(19) United States
(12) Patent Application Publication
(10) Pub. No.: US 2024/0328006 A1
(43) Pub. Date: Oct. 3, 2024

(54) ELECTROCHEMICAL CELL

(71) Applicant: NGK INSULATORS, LTD., Nagoya-shi (JP)

(72) Inventors: Genta TERAZAWA, Nagoya-shi (JP); Toshiyuki NAKAMURA, Handa-shi (JP); Takashi SHIRATORI, Nagoya-shi (JP); Makoto OHMORI, Nagoya-shi (JP)

(21) Appl. No.: 18/599,528

(22) Filed: Mar. 8, 2024

Related U.S. Application Data
(63) Continuation of application No. PCT/JP2023/013529, filed on Mar. 31, 2023.

(51) Int. Cl. C25B 11/032; C25B 9/23

(52) U.S. Cl. CPC C25B 11/032; C25B 9/23

(57) ABSTRACT

An electrochemical cell includes: a metal substrate having a principal surface and a plurality of connecting holes formed in the principal surface; and a cell body disposed on the principal surface. The cell body has: a gas diffusion layer disposed on the principal surface, the gas diffusion layer being electrically conductive; a first electrode layer disposed on the gas diffusion layer; a second electrode layer; and an electrolyte layer disposed between the first electrode layer and the second electrode layer. The first electrode layer has: a neighboring pore located near the gas diffusion layer; and a fine particle independently present within the neighboring pore.

### CROSS-REFERENCE TO RELATED APPLICATION

This is a continuation of PCT/JP2023/013529, filed on Mar. 31, 2023, the entire contents of which are hereby incorporated by reference.

### TECHNICAL FIELD

The present invention relates to an electrochemical cell.

### BACKGROUND ART

Electrochemical cells (electrolytic cells, fuel cells etc.) are conventionally known that have a cell body disposed on a metal substrate. The metal substrate has a plurality of connecting holes, which are formed in a principal surface thereof. The cell body has a first electrode layer formed on the principal surface of the metal substrate, a second electrode layer, and an electrolyte layer disposed between the first electrode layer and the second electrode layer.

Here, WO 2021/221052 describes interposing, between a cell body and a metal substrate, an adhesive (hereinafter referred to as a “gas diffusion layer”) that is gas-permeable and electrically conductive.

### SUMMARY

However, in the electrochemical cell described in WO 2021/221052, there is concern that a crack may occur in the first electrode layer if the first electrode layer is deformed by shear stress occurring between the gas diffusion layer and the first electrode layer due to a difference in thermal expansion coefficient between the metal substrate and the cell body.

An object of the present invention is to provide an electrochemical cell capable of preventing a crack from occurring in the first electrode layer.

An electrochemical cell according to a first aspect of the present invention includes: a metal substrate having a principal surface and a plurality of connecting holes formed in the principal surface; and a cell body disposed on the principal surface. The cell body has: a gas diffusion layer disposed on the principal surface, the gas diffusion layer being electrically conductive; a first electrode layer disposed on the gas diffusion layer; a second electrode layer; and an electrolyte layer disposed between the first electrode layer and the second electrode layer. The first electrode layer has: a neighboring pore located near the gas diffusion layer; and a fine particle independently present within the neighboring pore.

An electrochemical cell according to a second aspect of the present invention is the electrochemical cell of the first aspect, wherein the fine particle is a metal particle.

According to the present invention, it is possible to provide an electrochemical cell capable of preventing a crack from occurring in the first electrode layer.

### BRIEF DESCRIPTION OF DRAWINGS

FIG. 1 is a plan view of an electrolytic cell according to an embodiment.

FIG. 2 shows an A-A cross-section of FIG. 1.

FIG. 3 is a partial enlarged view of FIG. 2.

FIG. 4 is a schematic diagram illustrating a function of fine particles.

### DESCRIPTION OF EMBODIMENTS

### Electrolytic Cell 1

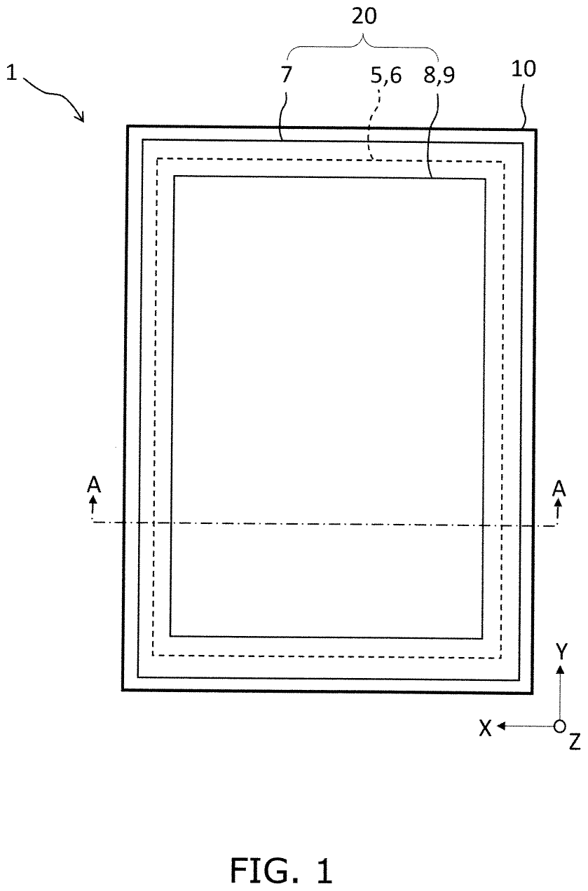

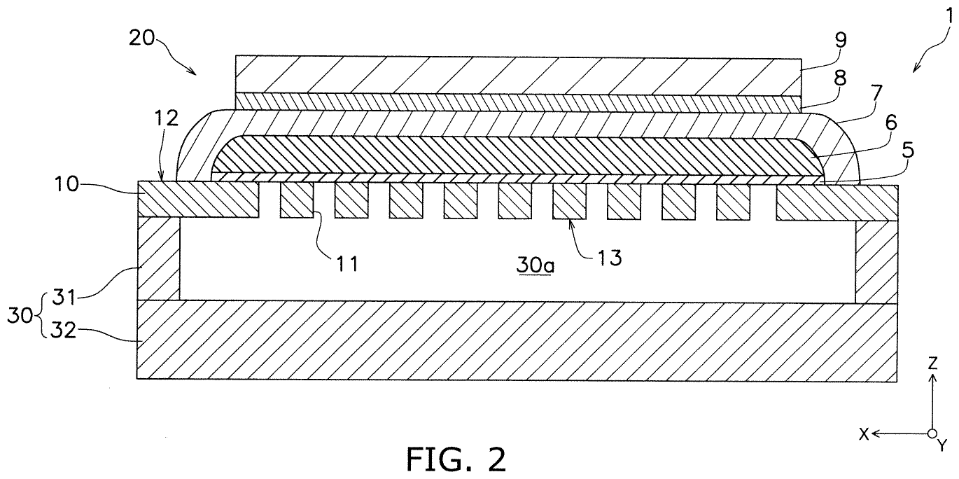

FIG. 1 is a plan view of an electrolytic cell 1 according to an embodiment. FIG. 2 shows an A-A cross-section of FIG. 1.

The electrolytic cell 1 is an example of an “electrochemical cell” according to the present invention. The electrolytic cell 1 is a so-called metal-supported electrolytic cell.

The electrolytic cell 1 has a plate shape expanding in an X-axis direction and a Y-axis direction. The electrolytic cell 1 in the present embodiment has a rectangular shape elongated in the Y-axis direction in a plan view from a Z-axis direction perpendicular to the X-axis direction and the Y-axis direction. However, the shape of the electrolytic cell 1 in the plan view is not specifically limited, and may alternatively be other than a rectangular shape, and may be a polygonal shape, an elliptic shape, a circular shape, or the like.

As shown in FIG. 2, the electrolytic cell 1 includes a metal substrate 10, a cell body 20, and a channel member 30.

### Metal Substrate 10

The metal substrate 10 supports the cell body 20. The metal substrate 10 has a plate shape. The metal substrate 10 may have a flat plate shape or a curved plate shape.

The metal substrate 10 need only be capable of supporting the cell body 20. The thickness of the metal substrate 10 is not specifically limited, but may be, for example, 0.1 mm or more and 2.0 mm or less.

As shown in FIG. 2, the metal substrate 10 has a plurality of connecting holes 11, a first principal surface 12, and a second principal surface 13.

Each connecting hole 11 extends through the metal substrate 10 from the first principal surface 12 to the second principal surface 13. Each connecting hole 11 is open in the first principal surface 12 and the second principal surface 13. In the present embodiment, the opening of each connecting hole 11 in the first principal surface 12 is covered by a later-described gas diffusion layer 5. The opening of each connecting hole 11 in the second principal surface 13 is continuous with a later-described channel 30a.

The connecting holes 11 can be formed by means of mechanical processing (e.g. punching), laser processing, chemical processing (e.g. etching), or the like.

Each connecting hole 11 in the present embodiment has a straight shape extending along the Z-axis direction. However, each connecting hole 11 may be inclined relative to the Z-axis direction, and need not necessarily has a straight shape. The connecting holes 11 may be continuous with each other.

The first principal surface 12 is an example of a “principal surface” according to the present invention. The first principal surface 12 is provided on the opposite side to the second principal surface 13. The cell body 20 is disposed on the first principal surface 12. The channel member 30 is joined to the second principal surface 13.

The metal substrate 10 is made of a metallic material. The metal substrate 10 is, for example, made of an alloy material containing Cr (chromium). Examples of such metallic materials include Fe—Cr alloy steel (stainless steel etc.) and Ni—Cr alloy steel. The content of Cr in the metal substrate 10 is not specifically limited, but can be 4% by mass or more and 30% by mass or less.

The metal substrate 10 may also contain Ti (titanium) and/or Zr (zirconium). The content of Ti in the metal substrate 10 is not specifically limited, but can be 0.01 mol % or more and 1.0 mol % or less. The content of Al in the metal substrate 10 is not specifically limited, but can be 0.01 mol % or more and 0.4 mol % or less. The metal substrate 10 may contain Ti in the form of TiO₂ (titania) and may contain Zr in the form of Zro₂ (zirconia).

The metal substrate 10 may have, on a surface thereof, an oxide film formed by oxidation of constituent elements of the metal substrate 10. A typical oxide film is, for example, a chromium oxide film. The chromium oxide film covers at least a portion of the surface of the metal substrate 10. The chromium oxide film may also cover at least a portion of an inner wall surface of each connecting hole 11.

### Cell Body 20

The cell body 20 is disposed on the metal substrate 10. The cell body 20 is supported by the metal substrate 10. The cell body 20 has a gas diffusion layer 5, a hydrogen electrode layer 6 (cathode), an electrolyte layer 7, a reaction-preventing layer 8, and an oxygen electrode layer 9 (anode).

The gas diffusion layer 5, the hydrogen electrode layer 6, the electrolyte layer 7, the reaction-preventing layer 8, and the oxygen electrode layer 9 are stacked in this order from the metal substrate 10 side in the Z-axis direction. The gas diffusion layer 5, the hydrogen electrode layer 6, the electrolyte layer 7, and the oxygen electrode layer 9 are essential components, and the reaction-preventing layer 8 is an optional component.

### Gas Diffusion Layer 5

The gas diffusion layer 5 is formed on the first principal surface 12 of the metal substrate 10. The gas diffusion layer 5 in the present embodiment covers the connecting holes 11 in the metal substrate 10. The gas diffusion layer 5 may be partially located within the connecting holes 11 of the metal substrate 10.

The gas diffusion layer 5 is an electrically conductive porous body having gas diffusion properties. The gas diffusion layer 5 supplies a source gas supplied from the connecting holes 11 to the hydrogen electrode layer 6, and discharges a gas produced in the hydrogen electrode layer 6 through the connecting holes 11.

The gas diffusion layer 5 contains an electrically conductive material. The electrically conductive material may be a metallic material, such as Ni (nickel) or Fe (iron), or an electrically conductive ceramic material.

The gas diffusion layer 5 may also contain a base material that supports the electrically conductive material. The base material may be insulating. The base material can be YSZ, CSZ, ScSZ, GDC, SDC, (La, Sr)(Cr, Mn)O₃, (La, Sr) TiO₃, Sr₂(Fe, Mo)₂O₆, (La, Sr)VO₃, (La, Sr)FeO₃, LDC (lanthanum-doped ceria), LSGM (lanthanum gallate), or a mixed material of two or more of these materials.

The gas diffusion layer 5 may contain a metallic element contained in the metal substrate 10. This brings the gas diffusion layer 5 and the metal substrate 10 into more intimate contact and is therefore preferable. Note that the aforementioned electrically conductive material is different from the metallic element contained in the metal substrate 10. Accordingly, the electrically conductive material contained in the gas diffusion layer 5 need not be contained in the metal substrate 10.

The porosity of the gas diffusion layer 5 is not specifically limited, but can be, for example, 20% or more and 40% or less.

The porosity of the gas diffusion layer 5 is calculated by the following method. First, hydrogen is supplied to the gas diffusion layer 5 and the hydrogen electrode layer 6 with the temperature of the electrolytic cell 1 raised to 750° C., thereby reducing the electrically conductive materials contained in the gas diffusion layer 5 and the hydrogen electrode layer 6. Next, the temperature of the electrolytic cell 1 is lowered while maintaining the reducing atmosphere, and the electrolytic cell 1 is cut along the thickness direction (Z-axis direction) to expose a cross section of the gas diffusion layer 5. Next, a backscattered electron image of the cross section of the gas diffusion layer 5 is acquired at a magnification of 10000 times using a SEM device (FE-SEM JSM-7900F, manufactured by JEOL Ltd.). Next, portions displayed in black (which correspond to pores) in the backscattered electron image are identified using image analysis software Image-Pro, manufactured by MEDIACYBERNETICS. Then, the porosity of the gas diffusion layer 5 is calculated by dividing the total area of the pores by the total area of the backscattered electron image of the gas diffusion layer 5.

The thickness of the gas diffusion layer 5 is not specifically limited, but can be, for example, 1 μm or more and 50 μm or less. The term “thickness” as used herein means the thickness in the thickness direction of the cell body 20. The term “thickness direction” refers to a direction perpendicular to a surface direction parallel to the first principal surface 12 of the metal substrate 10. The thickness direction is identified by using an approximate straight line of the first principal surface 12 that is obtained by the least squares method in a cross section of the metal substrate 10 along the Z-axis direction.

The method of forming the gas diffusion layer 5 is not specifically limited, and can be a sintering method, a spray coating method (thermal spray method, aerosol deposition method, aerosol gas deposition method, powder jet deposition method, particle jet deposition method, cold spray method etc.), a PVD method (sputtering method, pulsed laser deposition method etc.), a CVD method, or the like.

### Hydrogen Electrode Layer 6

The hydrogen electrode layer 6 is an example of a “first electrode layer” according to the present invention. The hydrogen electrode layer 6 is formed on the gas diffusion layer 5. The hydrogen electrode layer 6 is disposed between the gas diffusion layer 5 and the electrolyte layer 7.

The source gas is supplied to the hydrogen electrode layer 6 from the connecting holes 11 via the gas diffusion layer 5. The source gas contains at least H₂O.

When the source gas contains only H₂O, the hydrogen electrode layer 6 produces H₂ from the source gas in accordance with the electrochemical reaction of water electrolysis expressed by the following chemical equation (1).

Hydrogen electrode layer 6: H₂O+2e⁻→H₂+O²⁻ (1)

When the source gas contains CO₂ in addition to H₂O, the hydrogen electrode layer 6 produces H₂, CO, and O²⁻ from the source gas in accordance with the electrochemical reaction of co-electrolysis expressed by the following chemical equations (2), (3), and (4).

Hydrogen electrode layer 6: CO₂+H₂O+4e⁻→CO+H₂+2O²⁻ (2)

Electrochemical reaction of H₂O: H₂O+2e⁻→H₂+O²⁻ (3)

Electrochemical reaction of CO₂: CO₂+2e⁻→CO+O²⁻ (4)

The hydrogen electrode layer 6 is an electrically conductive porous body having gas diffusion properties. The source gas is supplied to the hydrogen electrode layer 6 from the gas diffusion layer 5. A gas produced in the hydrogen electrode layer 6 is discharged toward the gas diffusion layer 5.

The hydrogen electrode layer 6 contains an electrically conductive material. The electrically conductive material may be a metallic material, such as Ni (nickel) or Fe (iron), or an electrically conductive ceramic material. In the case of co-electrolysis, Ni also functions as a thermal catalyst to promote the thermal reaction between H₂ produced and CO₂ contained in the source gas and maintain a gas composition appropriate for methanation, reverse water-gas shift reactions, or the like.

The electrically conductive material exists in an oxide state (e.g. NiO) in an oxidizing atmosphere, and exists in a metallic state (e.g. Ni) in a reducing atmosphere. The present embodiment envisions that the electrolytic cell 1 is exposed to a reducing atmosphere.

The hydrogen electrode layer 6 contains an oxide ion-conductive material. The oxide ion-conductive material can be YSZ, CSZ, ScSZ, GDC, SDC, (La, Sr) (Cr, Mn)O₃, (La, Sr) TiO₃, Sr₂(Fe, Mo)₂O₆, (La, Sr)VO₃, (La, Sr)FeO₃, LDC, LSGM, or a mixed material of two or more of these materials.

In the present embodiment, the hydrogen electrode layer 6 has a single layer structure constituted by a single composition, but may alternatively have a multilayer structure constituted by different compositions.

The porosity of the hydrogen electrode layer 6 is not specifically limited, but can be, for example, 20% or more and 40% or less. The porosity of the hydrogen electrode layer 6 is calculated by dividing the total area of pores by the total area of the backscattered electron image of the hydrogen electrode layer 6, similarly to the aforementioned porosity of the gas diffusion layer 5.

The thickness of the hydrogen electrode layer 6 is not specifically limited, but can be, for example, 5 μm or more and 500 μm or less.

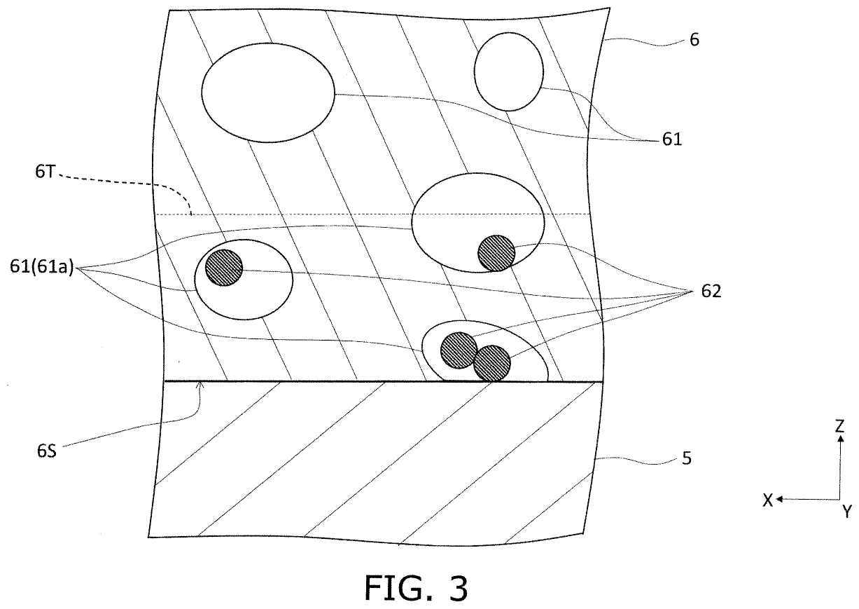

Here, FIG. 3 is a partial enlarged view of FIG. 2. As shown in FIG. 3, the hydrogen electrode layer 6 includes a plurality of pores 61 and a plurality of fine particles 62.

The plurality of pores 61 are dispersed within the hydrogen electrode layer 6 in a cross section of the hydrogen electrode layer 6. The shape and size of each pore 61 are not specifically limited, and may be different between the pores 61.

The mean equivalent circle diameter of the plurality of pores 61 is not specifically limited, but can be, for example, 20 μm or more and 40 μm or less. The mean equivalent circle diameter of the plurality of pores 61 is obtained by taking an arithmetic mean of the equivalent circle diameters of 30 pores 61 randomly selected from the backscattered electron image of the cross section of the hydrogen electrode layer 6. The equivalent circle diameter of a pore 61 is the diameter of a circle that has the same area as the pore 61.

The plurality of pores 61 include neighboring pores 61a located near the gas diffusion layer 5, as shown in FIG. 3. “Being located near the gas diffusion layer 5” means that at least a portion of each neighboring pore 61a is located within 5 μm (see a line 6T in FIG. 3) from an interface 6S between the gas diffusion layer 5 and the hydrogen electrode layer 6. Therefore, the neighboring pores 61a may be either in contact with the gas diffusion layer 5 or separated from the gas diffusion layer 5.

The fine particles 62 are disposed within the neighboring pores 61a. The fine particles 62 are independently present within the neighboring pores 61a. “Being independently present” means that the fine particles 62 are not fixed to inner surfaces of the pores 61. However, the fine particles 62 may be in contact with the inner surfaces of the pores 61. In the case where the fine particles 62 are in contact with the inner surfaces of the pores 61, the fine particles 62 being not fixed to the inner surfaces of the pores 61 can be confirmed based on a neck (e.g. a neck formed due to sintering) being not observed between the inner surface of each pore 61 and the outer surface of each fine particle 62.

The fine particles 62 being independently present within the neighboring pores 61a can prevent a crack from occurring in the hydrogen electrode layer 6, as described below.

Shear stress that occurs between the gas diffusion layers 5 and the hydrogen electrode layer 6 due to a difference in thermal expansion coefficient between the metal substrates 10 and the cell body 20 is absorbed by deformation of the neighboring pores 61a in the hydrogen electrode layer 6. At this time, if the fine particles 62 are not present, large shear stress may excessively deform the neighboring pores 61a, causing cracks around the neighboring pores 61a.

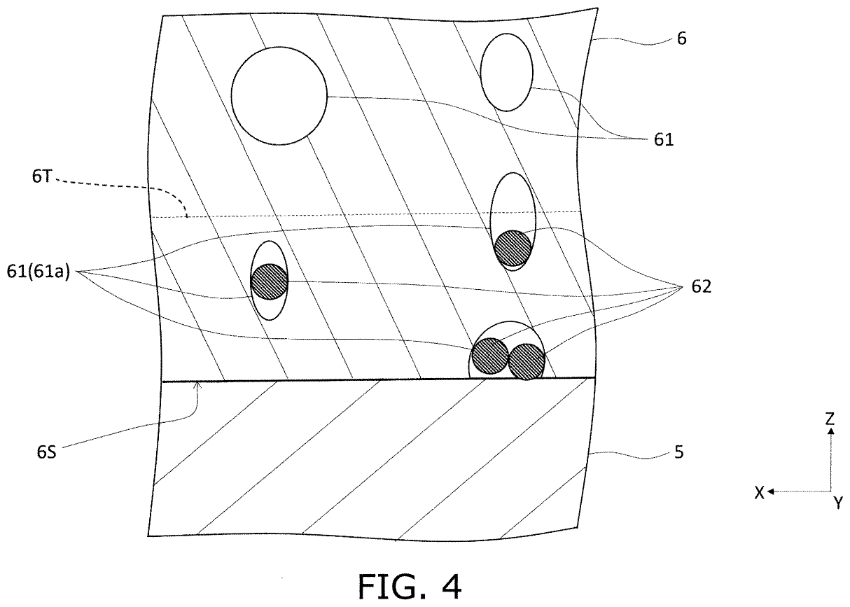

Meanwhile, the fine particles 62 in the present embodiment are independently present within the neighboring pores 61a. Each fine particle 62 is sandwiched between inner sides of a corresponding neighboring pore 61a as shown in FIG. 4, thereby supporting the neighboring pore 61a from the inside such that the neighboring pore 61a does not deform excessively. It is therefore possible to prevent a crack from occurring around the neighboring pores 61a. Particularly, since the fine particles 62 are not fixed to the inner surfaces of the neighboring pores 61a, the fine particles 62 can freely move within the neighboring pores 61a in response to deformation of the neighboring pores 61a. Therefore, the fine particles 62 can support the neighboring pores 61a from the inside regardless of the deformation direction of the neighboring pores 61a.

The constituent material of the fine particles 62 is not specifically limited, but can be, for example, ceramic particles, metal particles, or the like. Examples of the ceramic particles include NiO particles and F₂O₃ particles. Examples of the metal particles include Ni particles and Fe particles. Particularly, it is preferable that the fine particles 62 are ductile metal particles, since shear stress can also be absorbed by deformation of the fine particles 62. Examples of the ductile metal particles include Ni particles, Fe particles, and Co particles.

The particle diameter of each fine particle 62 is not specifically limited, but can be, for example, 0.1 μm or more and 5 μm or less. The number of fine particles 62 disposed in each neighboring pore 61a is not specifically limited, and need only be at least one. However, if each neighboring pore 61a is filled with the fine particles 62, it is difficult for shear stress to be absorbed by deformation of the neighboring pore 61a. It is therefore preferable that the fine particles 62 occupy only a portion of each neighboring pore 61a.

The method of forming the hydrogen electrode layer 6 is not specifically limited, and can be a sintering method, a spray coating method, a PVD method, a CVD method, or the like. For example, in the case of forming the hydrogen electrode layer 6 by means of the sintering method, a compact of the hydrogen electrode layer 6 can be formed by applying a slurry containing a pore former with the fine particles 62 embedded and the constituent material of the hydrogen electrode layer 6 onto a compact of the gas diffusion layer 5, and thereafter further applying the slurry containing the pore former and the constituent material of the hydrogen electrode layer 6. The neighboring pores 61a enclosing the fine particles 62 are formed as a result of the pore former with the fine particles 62 embedded disappearing while leaving the fine particles 62 in the process of sintering the compact of the hydrogen electrode layer 6.

### Electrolyte Layer 7

The electrolyte layer 7 is disposed between the hydrogen electrode layer 6 and the oxygen electrode layer 9. In the present embodiment, the reaction-preventing layer 8 is disposed between the electrolyte layer 7 and the oxygen electrode layer 9, and the electrolyte layer 7 is therefore sandwiched between the hydrogen electrode layer 6 and the reaction-preventing layer 8.

The electrolyte layer 7 covers the hydrogen electrode layer 6 and also covers a region of the first principal surface 12 of the metal substrate 10 that is exposed from the gas diffusion layer 5.

The electrolyte layer 7 transmits O²⁻ produced in the hydrogen electrode layer 6 toward the oxygen electrode layer 9. The electrolyte layer 7 is made of an oxide ion-conductive dense material. The electrolyte layer 7 can be made of, for example, YSZ (yttria stabilized zirconia; e.g. 8YSZ), GDC (gadolinium doped ceria), ScSZ (scandia stabilized zirconia), SDC (samarium solid solution ceria), LSGM (lanthanum gallate), or the like.

The porosity of the electrolyte layer 7 is not specifically limited, but can be, for example, 0.1% or more and 7% or less. The thickness of the electrolyte layer 7 is not specifically limited, but can be, for example, 1 μm or more and 100 μm or less.

The method of forming the electrolyte layer 7 is not specifically limited, and can be a sintering method, a spray coating method, a PVD method, a CVD method, or the like.

### Reaction-Preventing Layer 8

The reaction-preventing layer 8 is disposed between the electrolyte layer 7 and the oxygen electrode layer 9. The reaction-preventing layer 8 is disposed on the opposite side to the hydrogen electrode layer 6 with respect to the electrolyte layer 7. The reaction-preventing layer 8 prevents a constituent element of the electrolyte layer 7 from reacting with a constituent element of the oxygen electrode layer 9 to form a layer with high electrical resistance.

The reaction-preventing layer 8 is constituted by an oxide ion-conductive material. The reaction-preventing layer 8 can be made of GDC, SDC, or the like.

The porosity of the reaction-preventing layer 8 is not specifically limited, but can be, for example, 0.1% or more and 50% or less. The thickness of the reaction-preventing layer 8 is not specifically limited, but can be, for example, 1 μm or more and 50 μm or less.

The method of forming the reaction-preventing layer 8 is not specifically limited, and can be a sintering method, a spray coating method, a PVD method, a CVD method, or the like.

### Oxygen Electrode Layer 9

The oxygen electrode layer 9 is an example of a “second electrode layer” according to the present invention. The oxygen electrode layer 9 is disposed on the opposite side to the hydrogen electrode layer 6 with respect to the electrolyte layer 7. In the present embodiment, the reaction-preventing layer 8 is disposed between the electrolyte layer 7 and the oxygen electrode layer 9, and the oxygen electrode layer 9 is therefore connected to the reaction-preventing layer 8. If the reaction-preventing layer 8 is not disposed between the electrolyte layer 7 and the oxygen electrode layer 9, the oxygen electrode layer 9 is connected to the electrolyte layer 7.

The oxygen electrode layer 9 produces O₂ from O²⁻ transmitted from the hydrogen electrode layer 6 via the electrolyte layer 7, in accordance with the chemical reaction expressed by the following chemical equation (5).

Oxygen electrode layer 9: 2O²⁻→O₂+4e⁻ (5)

The oxygen electrode layer 9 is an oxide ion-conductive and electrically conductive porous body. The oxygen electrode layer 9 can be made of, for example, a composite material of an oxide ion-conductive material (GDC etc.) and at least one of (La, Sr) (Co, Fe)O₃, (La, Sr)FeO₃, La (Ni, Fe)O₃, (La, Sr)CoO₃, and (Sm, Sr)CoO₃.

The porosity of the oxygen electrode layer 9 is not specifically limited, but can be, for example, 20% or more and 60% or less. The thickness of the oxygen electrode layer 9 is not specifically limited, but can be, for example, 1 μm or more and 100 μm or less.

The method of forming the oxygen electrode layer 9 is not specifically limited, and can be a sintering method, a spray coating method, a PVD method, a CVD method, or the like.

### Channel Member 30

The channel member 30 is joined to the second principal surface 13 of the metal substrate 10. The channel member 30 forms a channel 30a between the channel member 30 and the metal substrate 10. The source gas is supplied to the channel 30a. The source gas supplied to the channel 30a is supplied to the hydrogen electrode layer 6 of the cell body 20 via the connecting holes 11 in the metal substrate 10.

The channel member 30 can be made of an alloy material, for example. The channel member 30 may be made of the same material as the metal substrate 10. In this case, the channel member 30 may be substantially integrated with the metal substrate 10.

The channel member 30 has a frame 31 and an interconnector 32. The frame 31 is an annular member that surrounds the sides of the channel 30a. The frame 31 is joined to the second principal surface 13 of the metal substrate 10. The interconnector 32 is a plate-shaped member for electrically connecting an external power source or another electrolytic cell to the electrolytic cell 1 in series. The interconnector 32 is joined to the frame 31.

The frame 31 and interconnector 32 in the present embodiment are separate members, but the frame 31 and interconnector 32 may alternatively be an integrated member.

### VARIATIONS OF EMBODIMENT

Although the embodiment of the present invention has been described above, the present invention is not limited thereto, and various changes can be made without departing from the gist of the invention.

### Variation 1

The fine particles 62 in the above embodiment are disposed within the neighboring pores 61a, of the plurality of pores 61 included in the hydrogen electrode layer 6. However, the fine particles 62 may also be disposed within the pores 61 other than the neighboring pores 61a, of the plurality of pores 61.

### Variation 2

In the present embodiment, the opening of each connecting hole 11 in the metal substrate 10 on the first principal surface 12 side is covered by the gas diffusion layer 5. However, this need not be the case. The gas diffusion layer 5 need not cover the opening of each connecting hole 11 on the first principal surface 12 side. In this case, the gas diffusion layer 5 has through holes connected to the respective connecting holes 11, and the gas can thus be more efficiently supplied and discharged through these through holes.

### Variation 3

In the above embodiment, the electrolytic cell 1 has been described as an example of an electrochemical cell. However, the electrochemical cell is not limited to an electrolytic cell. The term “electrochemical cell” is a general term for elements in which a pair of electrodes are disposed such that electromotive force is generated from the overall redox reaction in order to convert electrical energy to chemical energy, and elements for converting chemical energy into electrical energy. Accordingly, electrochemical cells include, for example, fuel cells that use oxide ions or protons as carriers.

### REFERENCE SIGNS LIST

1 Electrolytic cell
10 Metal substrate
11 Connecting hole
12 First principal surface
13 Second principal surface
20 Cell body
5 Gas diffusion layer
6 Hydrogen electrode layer
61 Pore
61a Neighboring pore
62 Fine particle
7 Electrolyte layer
8 Reaction-preventing layer
9 Oxygen electrode layer
30 Channel member
30a Channel

1. An electrochemical cell comprising:
a metal substrate having a principal surface and a plurality of connecting holes formed in the principal surface; and
a cell body disposed on the principal surface,
the cell body having:
a gas diffusion layer disposed on the principal surface, the gas diffusion layer being electrically conductive;
a first electrode layer disposed on the gas diffusion layer;
a second electrode layer; and
an electrolyte layer disposed between the first electrode layer and the second electrode layer, wherein
the first electrode layer has a neighboring pore located near the gas diffusion layer; and a fine particle independently present within the neighboring pore.

2. The electrochemical cell according to claim 1, wherein
the fine particle is a metal particle.
